(19) United States
(12) Patent Application Publication
(10) Pub. No.: US 2010/0122834 A1
(43) Pub. Date: May 20, 2010

(54) WIRE ORGANIZATION STRUCTURE

(76) Inventor: Shih-Hsing CHANG, Taipei City (TW)

Correspondence Address: Muncy, Geissler, Olds & Lowe, PLLC, P.O. BOX 1364, FAIRFAX, VA, 22038-1364, US

(21) Appl. No.: 12/274,791

(22) Filed: Nov. 20, 2008

(51) Int. Cl. H01B 7/00; F16G 11/00

(52) U.S. Cl. 174/135; 24/115 R

(57) ABSTRACT

A wire organization structure has two hollow wire holding ducts forms a wire running space thereinside. The wire running space has two ends formed a wire inlet and a wire outlet. A wire is provided with two ends threading through the wire inlet and wire outlet and movable for a displacement against the wire holding ducts. The two ends of the wire can be extended from the wire inlets towards the wire outlets for the displacement against the wire organization structure in a first use condition, and also are movable from the wire outlets towards the wire inlets and retained at the wire outlets in a second use condition. By threading the wire through two wire holding ducts, and pulling the wire to change the displacement against the wire organization structure, the length can be adjusted and use conditions can be altered. Wire organization and collection can be done faster.

### FIELD OF THE INVENTION

The present invention relates to an organization structure and particularly to a wire organization structure to collect and hold a wire in an orderly manner and adjust the wire at a desired length.

### BACKGROUND OF THE INVENTION

Rapid advance of technology has spawned a wide variety of electronic products in people's life, such as home appliances, stereos, televisions, computers and the like. They mostly require wires to transmit electric power or signals, such as telephone lines, power cords, cable TV wires and network lines and the like. While the wires and cables provide many benefits to people, they also create annoying problems such as inconvenient storing, space constraint, tangling and unsightly.

To remedy the aforesaid problems, many different types of wire collection and organization techniques have been proposed. References can be found in R.O.C. patent Nos. M291167, M327356, M328810 and M330003, China patent No. CN2935685, and U.S. Pat. Nos. 6,446,898 and 7,364,109. M291167, M327356 and M330003 disclose a protection shield for electronic devices that has a reel fastened to a back panel. The protection shield and the back panel are spaced from each other to form a wire collection room. The wire (such as an earphone wire) of an electronic device can be wound on the reel and held in the wire collection room. But in the event that the wire is lengthy winding of the wire could take a long time. When in use, unwinding in the opposite direction is needed.

M328810 also discloses a protection shield for holding an electronic device. It has a device holding pouch to hold the electronic device and a wire holding pouch located at one side of the device holding pouch. The wire holding pouch has an opening to receive the wire. When in use, the wire has to be arranged in advance in a suitable size to be loaded through the opening into the wire holding pouch. It does not provide wire organization function, hence the wire is easily entangled.

The techniques mentioned above require human labor to do wire collection. CN2935685, U.S. Pat. Nos. 6,446,898 and 7,364, 109 provide an automatic wire collector. They have a shell, a reel and an elastic element. The reel aims to wind a wire and is held in the shell. When the wire is drawn out, the reel is rotated against the shell. The elastic element provides elasticity to drive the reel to rotate in the opposite direction to wind and collect the wire. But the elastic element tends to have elastic fatigue after used for a period of time, and winding of the wire becomes not possible. Hence it has a limited life span. Moreover, the automatic wire collector has a complicated structure. In the event that any element is damaged, the shell has to be disassembled to remove the reel and elastic element to do repairs. And winding of the wire on the reel and loading of the elements into the shell have to be performed anew. Hence repairs and maintenance are difficult.

### SUMMARY OF THE INVENTION

The primary object of the present invention is to solve the aforesaid disadvantages and provide a reel that is simply structured to facilitate user operation.

To achieve the foregoing object, the invention provides a wire organization structure that has two wire holding ducts each is hollow inside to form a wire running space. The wire running space has two ends formed respectively a wire inlet and a wire outlet. A wire to be held has two ends threading through by entering the wire inlet and leaving the wire outlet. The two ends form respectively a moving displacement against each wire holding duct. The moving displacement at one end of the wire can be extended from the wire inlet towards the wire outlet to form a first use condition, while another displacement at the other end of the wire is directed from the wire outlet towards the wire inlet and retained and held at the wire outlet to form a second use condition. By having the two ends of the wire threaded through the wire holding ducts and formed displacements therewith, the length and use condition of the wire can be adjusted to facilitate user operation.

Compared with the conventional techniques, the invention provides many benefits such as orderly wire organization and faster wire collection.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is a schematic view of the invention for loading a wire.

FIGS. 3A and 3B are schematic views of a first embodiment of the invention in use conditions.

FIG. 4 is a schematic view of the first embodiment of the invention in a wire collecting condition.

FIG. 5 is a schematic view of the first embodiment of the invention in another wire collecting condition.

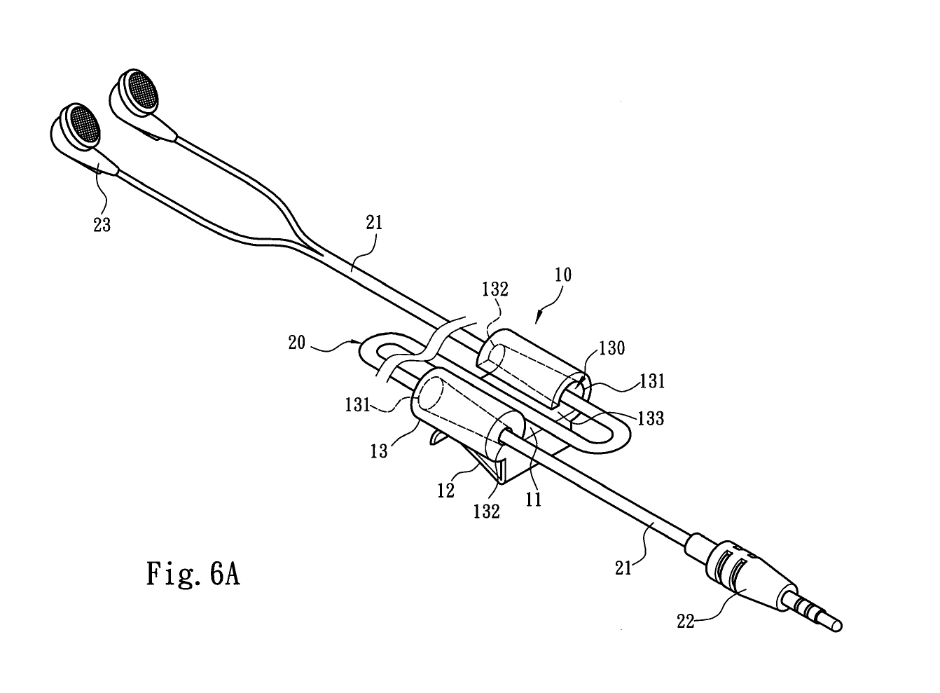

FIGS. 6A and 6B are schematic views of a second embodiment of the invention in use conditions.

FIGS. 7A and 7B are schematic views of a third embodiment of the invention in use conditions.

### DETAILED DESCRIPTION OF THE PREFERRED EMBODIMENTS

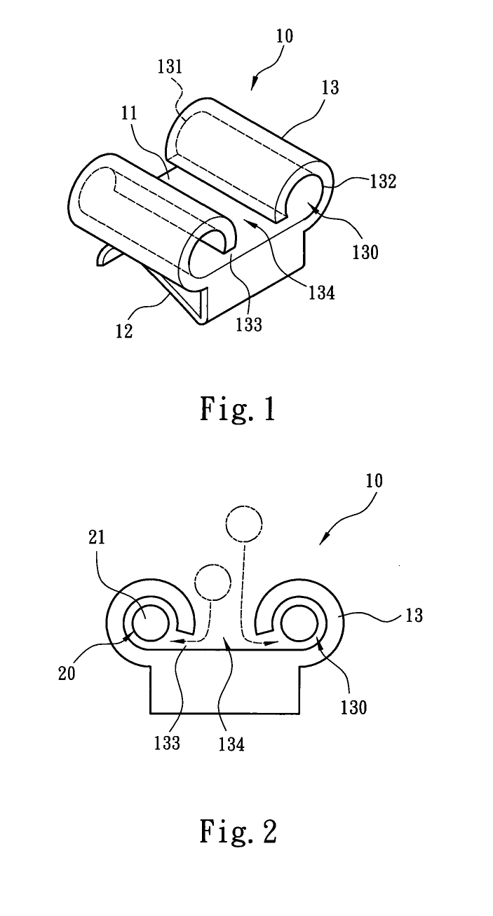

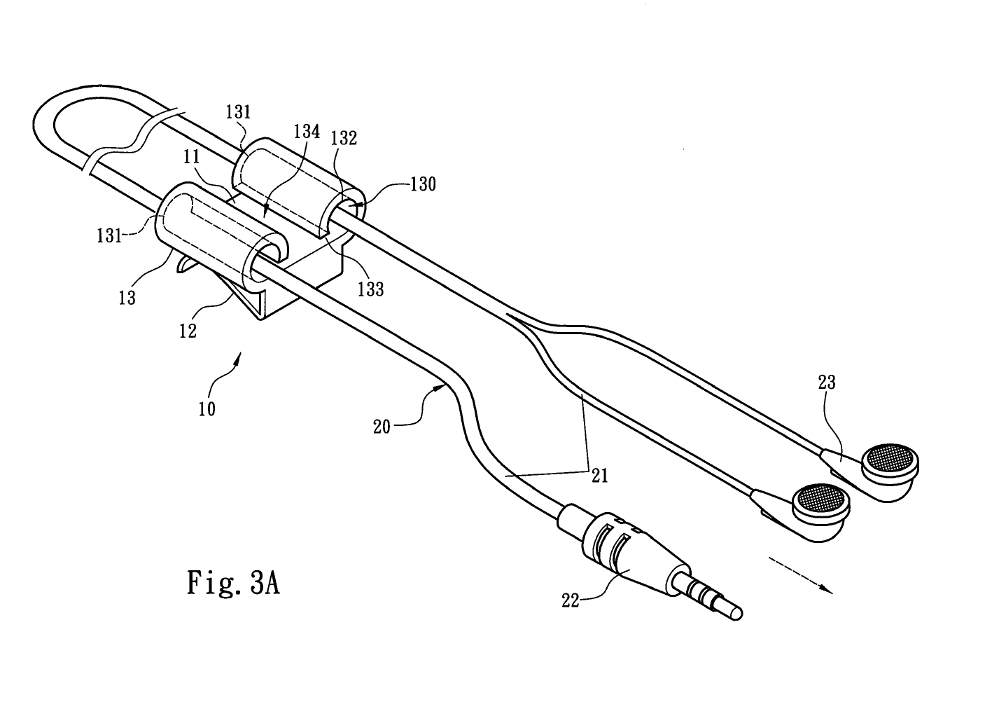

Please refer to FIGS. 1 and 2, the present invention provides a wire organization structure 10 which includes a base board 11, two wire holding ducts 13 located at one side of the base board 11 and a wire clipping portion 12 at the other side of the base board 11 opposite to the two wire holding ducts 13. The two wire holding ducts 13 are spaced from each other to form a winding trough 134 between them on the base board 11. Each of the wire holding ducts 13 is hollow inside to form a wire running space 130 which has two ends formed respectively a wire inlet 131 and a wire outlet 132. At least one wire holding duct 13 has a wire loading slot 133 communicating with the wire running space 130 to facilitate loading a wire 20 into the wire running space 130. The wire 20 has two ends threading through respectively the wire inlet 131 and wire outlet 132 to form a moving displacement against each wire holding duct 13.

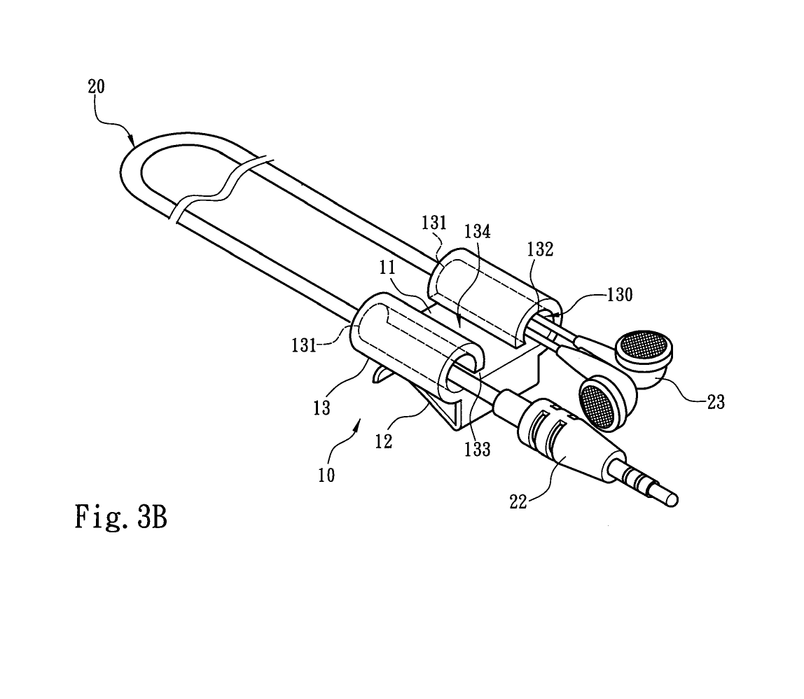

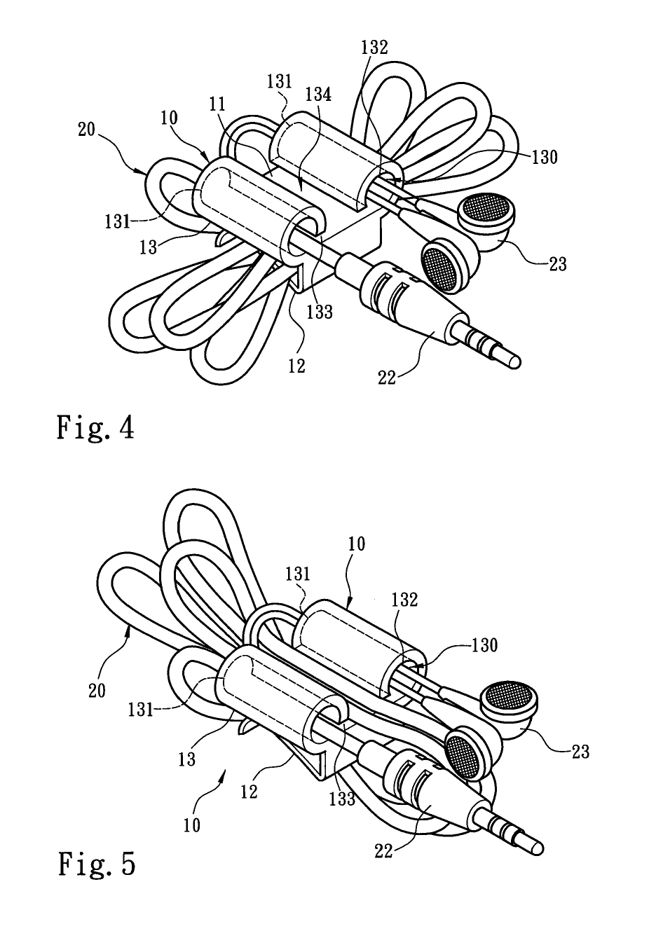

When in use, referring to FIGS. 3A and 3B for an embodiment in which the wire 20 is an earphone wire with two ends 21 running through the two wire holding ducts 13 and connecting respectively to a signal terminal 22 and a speaker 23. The wire outlets 132 of the two wire holding ducts 13 are at the same side so that the two ends 21 leave the two wire holding ducts 13 from the same side. The internal diameter of the wire holding ducts 13 is same as the wire inlet 131 and wire outlet 132. When one or two of the ends 21 are moved from the wire inlet 131 towards the wire outlet 132, the wire 20 is extended outside to form a first use condition (as shown in FIG. 3A). On the other hand, one or two of the ends 21 can also be moved from the wire outlet 132 towards the wire inlet 131, then the two ends 21 are retained at a storing position at the wire outlet 132 to form a second use condition (as shown in FIG. 3B). As the two ends 21 run through the entire wire holding ducts 13, at the retained and storing position at the wire outlet 132 the wire 20 between the two ends 21 are bent and shrunk at least one half of the length at one side where the wire inlet 131 is located. In the event that the wire 20 is still too long in the second use condition after bent in one half of length, referring to FIG. 4, it can be held in the wire clipping portion 12 of the base board 11; or wound on the winding trough 134 between the two wire holding ducts 13 to prevent tangling with other articles and being damaged during storing.

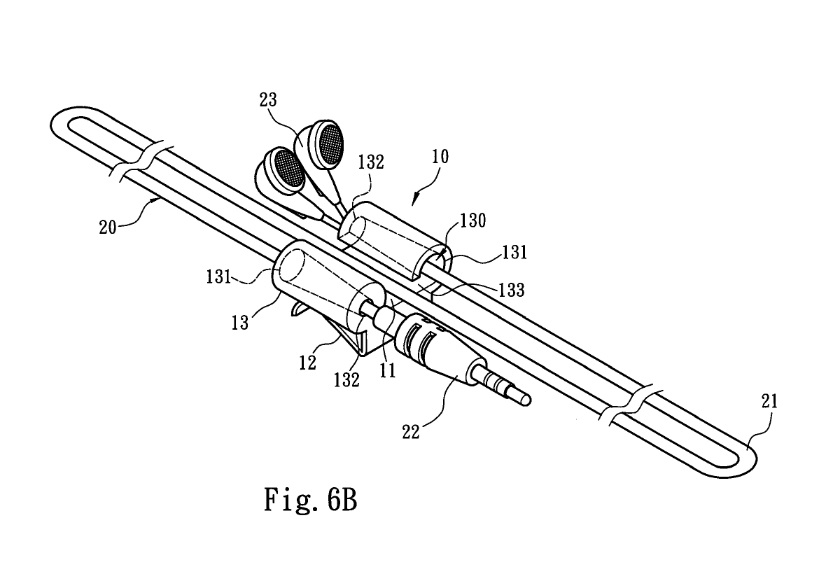

While the embodiment previously discussed has the wire outlets 132 at the same side of the wire holding ducts 13 to allow the two ends 21 to leave the wire organization structure 10 from the same side, FIGS. 6A and 6B illustrate a second embodiment in which the wire outlets 132 are formed at opposite sides of the two wire holding ducts 13. Hence the two ends 21 for the signal terminal 22 and the speaker 23 are exited from two different sides. Moreover, in this embodiment only one wire loading slot 133 is formed on one wire holding duct 13. The wire 20 is threaded through the other wire holding duct 13 in advance during fabrication. Moreover, the wire outlet 132 is formed at a diameter smaller than the wire inlet 131, and the internal diameter of each wire holding duct 13 shrinks gradually from the wire inlet 131 to the wire outlet 132. Use of this embodiment is substantially same as the one previously discussed. By pulling the signal terminal 22 and speaker 23 from the wire inlet 131 towards the wire outlet 132, the wire 20 is extended to form the first use condition (referring to FIG. 6A). By pulling the signal terminal 22 and speaker 23 in the opposite direction from the wire outlet 132 towards the wire inlet 131, the wire 20 is held in the second use condition. The smaller wire outlets 132 can clip and retain the signal terminal 22 and speaker 23 to prevent them form loosening off. The extra length of the wire 20 in the second use condition can be clipped in the wire clipping portion 12 or wound on the winding trough 134.

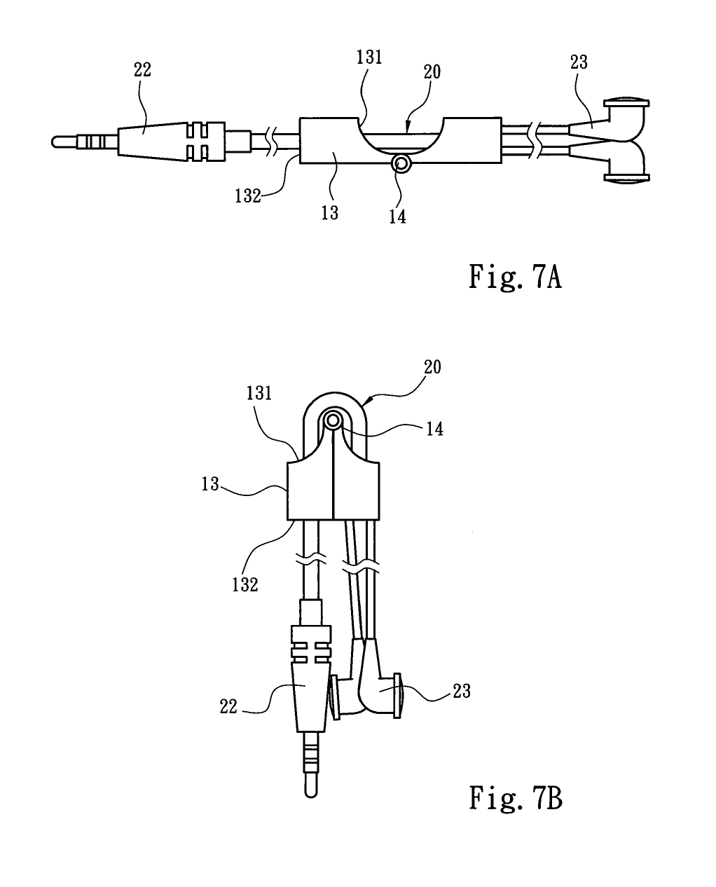

While the previously embodiments have the two wire holding ducts 13 mounted onto the base board 11, FIGS. 7A and 7B show a third embodiment which has a hinge 14 to bridge the two wire holding ducts 13. Thus the two wire holding ducts 13 can be pivotally turned relative to each other to change the use conditions. When the wire 20 threaded through the wire holding ducts 13 is in a use condition, the two wire holding ducts 13 are turned about the hinge 14 on a straight line with the wire inlets 131 opposing each other (referring to FIG. 7A). To store the wire 20, the two wire holding ducts 13 are turned about the hinge 14 in a juxtaposed manner (referring to FIG. 7B). Then the wire 20 can be pulled and collected through the wire inlets 13 1.

As a conclusion, the wire organization structure 10 of the invention has the two ends 21 of the wire 20 threading through the two wire holding ducts 13 to generate two moving displacements against the wire holding ducts 13. The whole structure is simpler and requires fewer elements than the conventional techniques. Repairs and maintenance also are easier. The length of the wire 20 during use can be adjusted according to requirements. By pulling the two ends 21 of the wire 20 can be bent at one half of length and retained at the wire outlets 132. Thus there is no need to wind the entire length of the wire on the reel as the conventional techniques do. Operation is simpler, and wire collection and organization can be done faster. It provides a significant improvement over the conventional techniques.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A wire organization structure to hold a wire in a first use condition with two ends of the wire extended from the wire organization structure and in a second use condition with the two ends thereof held and retained by the wire organization structure, comprising:
two wire holding ducts which are hollow inside to form a wire running space which has two ends formed respectively a wire inlet and a wire outlet, the two ends of the wire running through respectively the wire inlet and the wire outlet and movable for a displacement against each wire holding duct; the ends of the wire extended from the wire inlets towards the wire outlets against the wire organization structure at the displacement forming the first use condition; the ends of the wire moved from the wire outlets towards the wire inlets relative to the wire organization structure at the displacement to be held and retained thereof forming the second use condition.

2. The wire organization structure of claim 1, wherein at least one wire holding duct has a wire loading slot communicating with the wire running space to receive the wire.

3. The wire organization structure of claim 1 further having a base board to hold the two wire holding ducts.

4. The wire organization structure of claim 3, wherein the two wire holding ducts are spaced from each other to form a winding trough between them on the base board.

5. The wire organization structure of claim 3, wherein base board has a wire clipping portion at one side opposite to the two wire holding ducts.

6. The wire organization structure of claim 1, wherein the wire holding ducts are formed at an internal diameter the same as the wire inlet and the wire outlet.

7. The wire organization structure of claim 1, wherein the wire holding ducts are formed at an internal diameter shrinking gradually from the wire inlet towards the wire outlet.

8. The wire organization structure of claim 1 further having a hinge to bridge the two wire holding ducts.

9. The wire organization structure of claim 1, wherein the wire outlets of the two wire holding ducts are located at the same side.

10. The wire organization structure of claim 1, wherein the wire outlets of the two wire holding ducts are located at different sides.
